(19) United States
(12) Patent Application Publication
(10) Pub. No.: US 2017/0091042 A1
(43) Pub. Date: Mar. 30, 2017

(54) SYSTEM AND METHOD FOR POWER LOSS PROTECTION OF STORAGE DEVICE

(71) Applicant: Quanta Computer Inc., Taoyuan City (TW)

(72) Inventors: Le-Sheng CHOU, Taoyuan City (TW); Sz-Chin SHIH, Taoyuan City (TW)

(21) Appl. No.: 14/865,938

(22) Filed: Sep. 25, 2015

(51) Int. Cl. G06F 11/14; G06F 12/08; G06F 3/06

(52) U.S. Cl. CPC G06F 11/1415; G06F 3/0619; G06F 3/0659; G06F 3/0685; G06F 12/0804; G06F 12/0868; G06F 2212/1032; G06F 2212/60; G06F 2212/281; G06F 2212/313

(57) ABSTRACT

Embodiments generally relate to power loss protection in a computing system. The present technology discloses techniques that enable a graceful removal of power using a microcontroller controller in communication with a backup power supply. By utilizing a relative inexpensive microcontroller, the present technology can achieve data protection for a large number of storage devices at a low cost.

### FIELD OF THE INVENTION

The disclosure relates generally to power loss protection in a computing system.

### BACKGROUND

Data devices are vulnerable to data loss in the event of a sudden power loss, and thus usually require a gradual loss of power to preserve data integrity. For example, during a gradual loss of power, a system can properly store unsecured data to ensure data integrity.

Power loss protection (PLP) technology can provide the gradual loss of power by utilizing electrical capacitors with sufficient capacitance. During a normal operation, the electrical capacitors charge. Upon detecting a power loss of the system, the electrical capacitor can provide the requisite power for properly securing system and user data that are exposed to data loss risks.

Capacitor-based PLP technology can provide a data protection solution to unexpected power loss in storage devices. However, the high density of storage devices, e.g., in a storage area network (SAN), presents a challenge for providing an efficient yet economic power loss protection technology.

### SUMMARY

Aspects of the present technology disclose techniques that enable a graceful removal of power using a management central processing unit (CPU) in communication with a backup power supply. By utilizing a relative inexpensive management CPU, the present technology can achieve data protection for a massive number of storage devices with high efficiency and scalability.

According to some embodiments, the present technology discloses a computer-implemented method, comprising: detecting, at a data protection controller associated with a storage device of a computing device, a signal indicating a power loss to the computing device, first generating, in response to the signal, using power supplied by a backup power unit of the computing device, an input/out interruption command for a switch device associated with the storage device, second generating a flush cache command for a storage controller of the computing device, first transmitting the input/out interruption command to the switch device, the switch configured to disable transmission of at least one input/output command, second transmitting the flush cache command to the switch device, the switch device configured to transmit the flush cache command to the storage controller of the computing device; and executing a clean power-off of the computing device.

According to some embodiments, before generating commands to initiate the clean power-off process, the data protection controller can wait for a predetermined period of time that can be based at least in part on a period of time for which the backup power unit can provide sufficient power to the computing device.

According to some embodiments, a management CPU, e.g. a data protection controller, can communicate with a PCIe switch to provide a gradual or clean power removal process. A management CPU can detect a power loss at a computing device by monitoring an electrical power input line. The management CPU can, consequently, issue commands to a PCIe switch to reject new IO commands (user data) from the host device. The management CPU can also send the Flush Cache command to the PCIe switch, which can broadcast the command to each associated storage device so that the unsaved system data and user data can be properly stored and recovered later.

According to some embodiments, the management CPU can be a X86 based CPU or ARM based CPU. A BMC, as an ARM based CPU, can be responsible for the management and monitoring of the main central processing unit and peripheral devices on the motherboard. For example, a BMC can communicate with other internal computing components via Intelligent Platform Management Interface (IPMI) messages. A BMC can communicate with external computing devices using Remote Management Control Protocol (RMCP). Alternatively, a BMC can communicate with external devices using RMCP+ for IPMI over LAN. Additionally, other service controller, such as a Rack Management Controller (RMC), can enable a gradual power removal process as disclosed herein.

According tom some embodiments, a storage device can be any storage medium configured to store program instructions or data for a period of time. For example, it can be a solid state drive (SSD), a hard drive disk (HDD), a flash drive, or a combination thereof.

According to some embodiments, a backup power unit is an additional power supply that is configured to supply sufficient power for a gradual power-off the system. For example, a backup power unit can be an uninterruptable power supply (UPS) unit.

Although many of the examples herein are described with reference to a PCIe bus, it should be understood that these are only examples and the present technology is not limited in this regard. Rather, any system bus that provides connections between computer components may be used, such as the Industry standard architecture (ISA) I/O Bus, or VESA Local Bus (VLB).

Additionally, even though the present disclosure uses solid state drive (SSD) as an example of the storage devices, the present technology is applicable to other storage devices or components that can suffer data loss caused by an unexpected power removal, such as a hard drive disk (HDD) or a flash drive.

Additional features and advantages of the disclosure will be set forth in the description which follows, and, in part, will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Various embodiments or examples (“examples”) of the invention are disclosed in the following detailed description and the accompanying drawings:

FIG. 1 illustrates a schematic block diagram including a server with a PCIe switch and a solid state drive, according to some embodiments;

FIG. 2 is another schematic block diagram illustrating an example of a server with a plurality of PCIe switches associated with a plurality of solid state drives, according to some embodiments;

FIG. 3 illustrates a schematic block diagram of a PCIe switch, according to some embodiments;

FIG. 4 is an example flow diagram for a power loss protection system, according to some embodiments;

FIG. 5 is another example flow diagram for a power loss protection system, according to some embodiments; and

FIG. 6 illustrates a computing platform of a computing device, according to some embodiments.

### DETAILED DESCRIPTION

Various embodiments of the present technology are discussed in detail below. While specific implementations are discussed, it should be understood that this is done for illustration purposes only. A person skilled in the relevant art will recognize that other components and configurations may be used without departing from the spirit and scope of the present technology.

Data centers with a large quantity of storage devices (e.g., SSDs) are constantly exposed to unforeseeable power loss caused by extreme weather, power grid failures or system malfunctions. As unexpected power loss can cause critical and irreparable data loss, some storage devices have embedded power loss protection (PLP) technology to reduce data loss possibilities.

PLP technology utilizes on-board electrical capacitors to provide a graceful shut-down of the system at an abrupt power removal. Graceful shut-down of the system includes sending commands (e.g., the standby immediate command) to the storage device indicating that power might be imminently removed. The storage device can consequently flush its volatile cache content or any in-transit data to a permanent storage medium. Additionally, a host system driver can send the commands to the storage device.

However, this PLP technology requires expensive high-performance capacitors (e.g., electrolytic tantalum capacitors or aluminum capacitors) to be embedded in the storage device, which increases the design complexity as well as manufacture costs. As such, the capacitor-based PLP technology is not suitable for the clustered computing environment where a large number of storage devices need to be protected from data loss.

Thus, there is a need to provide an efficient data protection method and system for storage devices, which can offer both power loss protection and computing scalability.

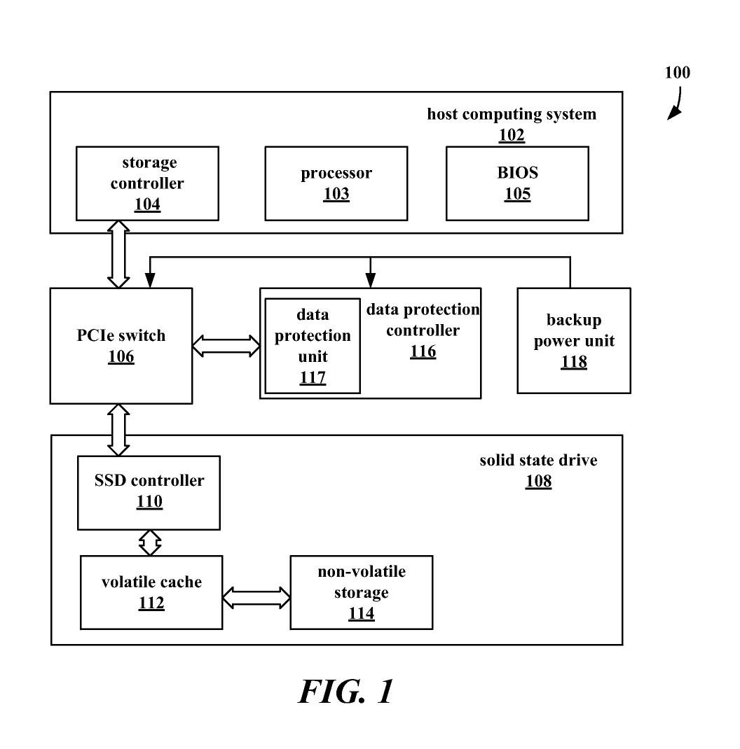

FIG. 1 illustrates a schematic block diagram including a server with a PCIe switch and a solid state drive, according to some embodiments. It should be appreciated that the topology in FIG. 1 is an example, and any numbers of servers, SSDs and network components may be included in the system of FIG. 1.

A server 100 can include a host computing system 102 in communication with a PCIe switch 106, a data protection controller 116, a backup power unit 118 and a solid state drive 108. When host computing system 102 experiences a sudden power loss, data protection controller 116 can detect signals indicating the power loss, e.g., by receiving a power signal from host computing system 102. In response to the power loss signal(s), data protection controller 116 can use power supplied by backup power unit 118 to generate various commands to initiate a gradual or clean power-off process of server 100.

Host computing system 102 can be any suitable hosting device that is associated with a storage device. Host computing system 102 can include storage controller 104 that is operable to handle user data and system data between host computing system 102 and solid state drive 108. For example, storage controller 104 can issue I/O commands to solid state drive 108. Additionally, host computing system 102 can include additional mechanism to ensure data integrity, such as disk recovery.

BIOS 105 can be any program instructions or firmware configured to initiate and identify various components of host computing system 102, including device such as a keyboard, a display, a data storage device, and other input or output devices. BIOS 105 can be stored in a storage device (not shown) and be accessed by processor 103 during a booting process.

Processor 103 can be a central processing unit (CPU) configured to execute program instructions for specific functions. For example, during a booting process, processor 103 can access BIOS 105 stored in a BIOS memory and execute BIOS 105 to initialize host computing system 102. During the booting process, processor 103 can execute software instructions in order to identify and manage solid state drive 108.

PCIe switch 106 can be a PCIe hos bus adapter that is operable to implement PCIe system bus in server 100. The PCIe system bus can enable computing components, including processor, chipset, cache, memory, expansion cards, and storage devices, to communicate with each other. The PCIe bus is a high-speed serial computer I/O (Input/Output) system bus for connecting various peripheral devices. By utilizing point-to-point serial lines instead of a shared parallel bus architecture, a PCIe bus is able to provide high-bandwidth and low-latency data transmission, e.g. over 30 GB/s, for a version 4.0 16-lane slot, in each direction.

In addition to PCIe bus, the present technology can use other system buses implemented by host bus adapters such as such as the Serial ATA Express (SATA) adapter or the Serial-attached SCSI (SAS) adapter.

Solid state drive 108 can use integrated circuit assemblies as memory to store data. Compared with electromechanical disks, solid state drive 108 can offer technical advantages including resistance to physical damage and less data access latency. Additionally, embodiments herein can be applied to other storage medium operable to store program instructions or data for a period of time. For example, the storage medium can be a flash drive, a hard-disk drive (HDD), or a combination thereof.

Volatile cache 112 can be a high speed random access memory (RAM) operable to retain data as long as power is provided. For example, volatile cache 112 can include a static random access memory (SRAM) which can provide fast data storage and retrieval. Alternatively, volatile cache 112 can include a dynamic random access memory (DRAM), which can be refreshed constantly to process data. Volatile cache 112 can be either independent from SSD controller 110 or embedded in SSD controller.

According to some embodiments, volatile cache 112 can be operable to store metadata tables. Metadata tables are operable to store the virtual to physical mapping information for implementing a flush-translation mechanism. In a flush-translation mechanism, the frequent allocation of data in non-volatile storage 114 can require 1) informing virtual data location information to the operation system, and 2) constantly translating the virtual location information to the changing physical location on the non-volatile storage 114. Due to its frequent modification, at least part of the metadata tables can be saved in volatile cache 112 to improve the access time. Additionally, volatile cache 112 can be operable to temporarily store other uncommitted user data and system data. During the power-off process, data stored in volatile cache 112 can be committed into non-volatile storage 114 after receiving a flush cache command, as disclosed later in the specification.

Non-volatile storage 114 can be any storage medium that is operable to retain data when power is off. For example, non-volatile storage 114 can be a non-volatile flush memory such as a NAND memory, a NOR memory, or a combination thereof.

Data protection controller 116 can be any management CPU that is operable to manage the data protection at the event of an abrupt power loss. According to some embodiments, data protection controller 116 can be a Baseboard Management Controller (BMC). A BMC is an independent and embedded management CPU that, in some embodiments, is responsible for the management and monitoring of the main central processing unit and peripheral devices on the motherboard. For example, a BMC can communicate with other internal computing components via Intelligent Platform Management Interface (IPMI) messages. A BMC can communicate with external computing devices using Remote Management Control Protocol (RMCP). Alternatively, a BMC can communicate with external devices using RMCP+ for IPMI over LAN. Additionally, other service controllers, such as a Rack Management Controller (RMC), can enable a gradual power removal process as disclosed herein.

Data protection unit 117 can be an embedded circuit, or software instructions that, when executed, are operable to provide data protection to stolid state drive 108. For example, data protection unit 117 can detect a power loss of computing system 102 by receiving a power signal indicating a power loss. Data protection unit 117 can also receive signals from a voltage meter associated with a regular power supply (not shown) of host computing system 102.

Still referring to FIG. 1, upon receiving the power loss signal, data protection unit 117 or data protection controller 116 can generate input/output interruption commands that are operable to cause PCIe switch 106 to stop receiving I/O commands from storage controller 104. For example, PCIe switch 106 can disable transmission of I/O commands from storage controller 104.

Data protection unit 117 or data protection controller 116 can also generate flush cache commands and transmit them to PCIe switch 106. PCIe switch 106 can consequently transmit or broadcast the flush cache commands to SSD controller 110 via PCIe system interface, which is configured to save unsaved data in volatile cache 112 to non-volatile storage 114 in turn.

SSD controller 110 can be any microcontroller that is operable to execute firmware level software instructions related to solid state drive 108. In response to the flush cache commands, SSD controller 110 can, using power supplied by backup power unit 118, store unsaved data from volatile cache 112 to non-volatile storage 114. The unsaved data exposed to the loss at least includes: 1) in-transit user data and system data between the host system and the storage device; and 2) uncommitted data that is temporarily stored in the volatile cache of the storage device.

For example, in-transit user data can be IO write commands that has left host computing system 102 and has not arrived at SSD controller 110. IO write commands can be new or modified user data or system data. On the other hand, IO read commands are not subject to data loss impact as they are related to a request to read data already stored in non-volatile storage 114. According to some embodiments, SSD controller can commit the in-trans user data to non-volatile storage 114.

Uncommitted data can be any data that is temporarily stored in volatile cache 112 and would be lost when volatile cache 112 loses the power. For example, theses uncommitted data can include system data such as metadata tables as described earlier in the specification. Upon receiving the flush commands from PCIe switch 106, SSD controller 110 can synchronize the metadata tables stored in volatile cache to non-volatile storage 114 to prevent data loss.

Upon detecting a power loss at host computing system 102, backup power unit 118 is configured to provide the additional power to allow a clean shutdown of server 100. Backup power unit 118 can be any backup power supplies that can provide emergency power to the system when the main input power source fails. For example, backup power unit 118 can be an uninterruptable power supply (UPS) unit, a regular battery, or a combination thereof.

Further, before generating the flush cache commands, data protection controller 116 can wait for a predetermined period of time (e.g., several second) for a power recovery of host computing system 102. During this predetermined period of time, backup power unit 118 can supply the requisite power to host computing system 102 for a normal operation. This feature can avoid an unnecessary shut-down at the event of a brief power loss. Additionally, data protection controller 116 can determine the predetermined period for which back power unit 118 can provide sufficient power for host computing system 102 to operate normally. Approaching the predetermined period of time, if the main power has not been resumed, data protection controller 116 can initiate the clean shut-down process, including generate 1) an I/O interruption command to disenable PCIe switch 106 to receive more I/O commands; and 2) the flush cache commands to PCIe switch 106 to be transmitted to solid state drive 108 for a clean power-off as disclose herein.

According to some embodiments, SSD controller 110 can generate an acknowledge command to indicate that all the unsaved data has been committed to non-volatile storage 114. SSD controller 110 can transmit the acknowledge command to PCIe switch 106 and data protection controller 116, which can in turn remove the power form backup power unit 118.

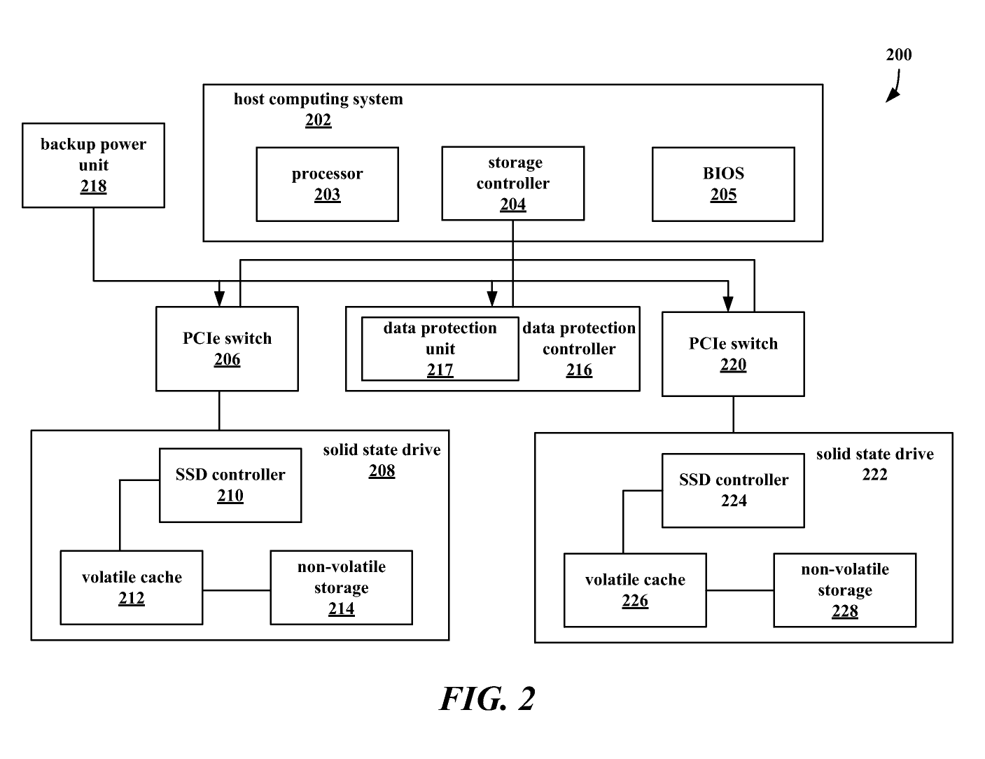

FIG. 2 is another schematic block diagram illustrating an example of a plurality of PCIe switches associated with a plurality of solid state drives, according to some embodiments. It should be appreciated that the topology in FIG. 2 is an example, and any numbers of servers, SSDs and network components may be included in the system of FIG. 2.

A server 200 can include a host computing system 202 in communication with a plurality of PCIe switches including, at least, PCIe switch 206 and 220, a data protection controller 216, a backup power unit 218 and a plurality of solid state drives including, at least, solid state drive 208 and 222. As illustrated in FIG. 2, a respective PCIe switch is operable to communicate with a respective solid state drive as disclosed herein.

Host computing system 202 can be any suitable hosting device that operable to communicate with a plurality of storage devices. Host computing system 202 can include storage controller 204 that is operable to handle user data and system data between host computing system 202 and solid state drive 208 and 222. For example, storage controller 204 can respectively issue I/O commands to solid state drive 208 and 222. Additionally, host computing system 202 can include additional mechanism to ensure data integrity, such as disk recovery mechanism.

BIOS 205 can be any program instructions or firmware configured to initiate and identify various components of host computing system 202, including device such as a keyboard, a display, a data storage device, and other input or output devices. BIOS 205 can be stored in a storage device (not shown) and be accessed by processor 203 during a booting process.

Processor 203 can be a central processing unit (CPU) configured to execute program instructions for specific functions. For example, during a booting process, processor 203 can access BIOS 205 stored in a BIOS memory and execute BIOS 205 to initialize host computing system 202. During the booting process, processor 203 can execute software instructions in order to identify and manage solid state drive 208 and 222 respectively.

PCIe switch 206 or PCIe switch 220 can be a PCIe host bus adapter that is operable to implement PCIe system bus in server 200. In addition to PCIe bus, the present technology can use other system buses implemented by host bus adapters such as such as the Serial ATA Express (SATA) adapter or the Serial-attached SCSI (SAS) adapter.

Solid state drive 208 or solid state drive 222 can use integrate circuit assemblies as memory to store data. Solid state drive 208 can include by way of non-limiting example, volatile cache 212 and non-volatile storage 214. Similarly, solid state drive 222 can include volatile cache 226 and non-volatile storage 228. Additionally, embodiments herein can be applied to other storage medium operable to store program instructions or data for a period of time. For example, the storage medium can be a flash drive, a hard-disk drive (HDD), or a combination thereof.

According to some embodiments, a solid state drive (e.g., solid state drive 208) can be associated with a unique identifier, such as a globally unique identifier (GUID) or a universally unique identifier (UUID) for identification with other network component. A GUID can have a 128-bit value and be displayed as 32 hexadecimal digits with hyphen-separated groups, e.g., 3AEC1226-BA34-4069-CD45-12007C340981. A UUID can also have a 128-bit value and be displayed in a format that is similar to a GUID.

Volatile cache 212 can be a high speed random access memory (RAM) operable to retain data as long as power is provided. For example, volatile cache 212 can include a static random access memory (SRAM) which can provide fast data storage and retrieval. Alternatively, volatile cache 212 can include a dynamic random access memory (DRAM), which can be refreshed constantly to process data. Volatile cache 212 can be either independent from SSD controller 210 or embedded in SSD controller 210.

According to some embodiments, volatile cache 212 can be operable to store metadata tables. Metadata tables are operable to store the virtual to physical mapping information for implementing a flush-translation mechanism. Due to its frequent modification, at least part of the metadata tables can be saved in volatile cache 212 to improve the access time. Additionally, volatile cache 212 can be operable to temporarily store other uncommitted user data and system data. During the power-off process, in response to receiving a flush cache command, data stored in volatile cache 212 can be committed into non-volatile storage 214 to avoid data loss, as disclosed herein.

Non-volatile storage 214 can be any storage medium that is operable to retain data when power is off. For example, non-volatile storage 214 can be a non-volatile flush memory such as a NAND memory, a NOR memory, or a combination thereof.

Data protection controller 216 can be any management CPU that is operable to manage the data protection feature for server 200 at the event of an abrupt power loss. According to some embodiments, data protection controller 216 can be a BMC. According to some embodiments, data protection controller 216 can include data protection unit 217.

Data protection unit 217 can be an embedded circuit, or software instructions that, when executed, are operable to provide data protection to a plurality of solid state drives such as stolid state drive 208 and solid state drive 222. For example, data protection unit 217 can detect a power loss of computing system 202 by receiving a power signal indicating a power loss. Data protection unit 217 can also receive signals from a voltage meter associated with a regular power supply (not shown) of host computing system 202.

Upon receiving the power loss signal, data protection unit 217 or data protection controller 216 can generate input/output interruption commands that are operable to prevent a plurality of PCIe switches to receive I/O commands from storage controller 204. For example, PCIe switch 206 can disable transmission of I/O commands from storage controller 204.

Data protection unit 217 or data protection controller 216 can generate flush cache commands and transmit them to PCIe switch 206 and PCIe switch 220 respectively. For example, PCIe switch 206 can consequently transmit or broadcast the flush cache commands to SSD controller 210, which is configured to save unsaved data in volatile cache 212 to non-volatile storage 214. Similarly, PCIe switch 220 can broadcast the flush cache commands to its corresponding SSD controller 224 for flushing out unsaved data to non-volatile storage 228.

Still referring to FIG. 2, when host computing system 202 experiences an unexpected power loss, data protection controller 216 can detect signals indicating the power loss, e.g., by receiving data indicating a power loss from host computing system 202. In response to the power loss signals, data protection controller 216 can generate I/O interruption commands to PCIe switch 206 and 220. The I/O interruption commands can enable PCIe switch 106 and 220 to stop receiving I/O write commands and I/O read commands from storage controller 204.

SSD controller 210 or SSD controller 224 can be any management CPU that is operable to execute firmware level software instructions related to a solid state drive. For example, in response to the flush cache commands, SSD controller 210 can, using power supplied by backup power unit 218, store unsaved data from volatile cache 212 to non-volatile storage 214. The unsaved data exposed to the loss at least includes in-transit user data and system data between the host system and the storage device and uncommitted data that are temporarily stored in the volatile cache of the storage device, as disclosed herein. Upon receiving the flush commands from PCIe switch 206, SSD controller 210 can commit the in-transit user data to non-volatile storage 214 and synchronize the metadata tables stored in volatile cache 212 to non-volatile storage 214 to prevent data loss.

Upon detecting a power loss at host computing system 202, backup power unit 218 is configured to provide the additional power to allow a graceful power down of server 200. Backup power unit 218 can be any backup power supplies that can provide emergency power to the system when the main input power source fails. For example, backup power unit 118 can be an uninterruptable power supply (UPS) unit.

Further, before generating the flush cache commands, data protection controller 216 can wait for a predetermined period of time (e.g., several second) for a power recovery of host computing system 202. During this predetermined period of time, backup power unit 218 can supply the requisite power to host computing system 202 for a normal operation. This feature can avoid an unnecessary shut-down at the event of a brief power loss.

Additionally, data protection controller 216 can determine an estimated period for which back power unit 218 can provide sufficient power. Approaching the estimated period, data protection controller 216 can then generate the flush cache commands to PCIe switches to be transmitted to solid state drives for a clean power off, as disclose herein.

According to some embodiments, SSD controller 210 or 222 can generate an acknowledge command to indicate that all the unsaved data has been committed to non-volatile storages. For example, SSD controller 210 can transmit the acknowledge command to PCIe switch 206 and data protection controller 216, which can in turn remove the power form backup power unit 218. Additionally, SSD controller 210 can include a unique identifier associated with solid state drive 208 (e.g., a GUID or a UUID) for identification by data protection controller 216.

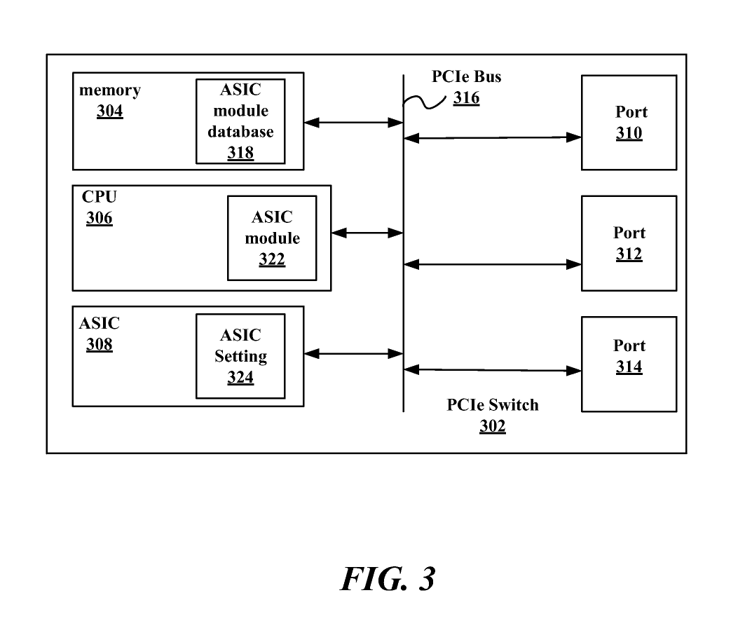

FIG. 3 illustrates a schematic block diagram of a PCIe switch, according to some embodiments. A PCIe switch can include a central processing unit (CPU) and an application-specific integrated circuit (ASIC) that is operable to provide the data switching function. For example, PCIe switch 302 can include, without limited to, memory 304, CPU 306, ASCI 308, and a plurality of ports including ports 310, 312 and 314.

According to some embodiments, CPU 306 can be interconnected with ASIC 308 via as PCIe bus 316. ASIC 308 can be a switch IC that can include a switch controller, a memory, and I/O interfaces (not shown). According to some embodiments, ASIC 308 can be associated with ASIC setting 324 such as lookup tables that can associate a port with a corresponding medium access control (MAC) address. For example, PCIe switch 302 can determine a forwarding path of a packet by identifying a destination MAC address in a packet header. It can further associate the destination MAC address with a corresponding output port. Further, ASIC 308 can transmit packets to the network by an uplink such as Ethernet.

According to some embodiments, PCIe switch 302 can include memory 304 operable to store switching-related data. Memory 304, for example, can be a dual in-line memory module (DIMM) that can include a group of dynamic random-access memory. Memory technology is well known by those skilled in the art so that further description thereof is unnecessary.

According to some embodiments, CPU 306 can execute ASIC module 322 and generate ASIC module database 318 that can be stored in memory 304. ASIC module database 318 can store various network parameters, for example, mapping of ASIC setting 309 for network functions.

According to some embodiments, PCIe switch 302 can further include a group of ports such as Port 310, Port 312 and Port 314, each of which can be associated with a network device, e.g., a solid state drive or a computing node. Additionally, one or more of these ports can be input ports or output ports for packet switching.

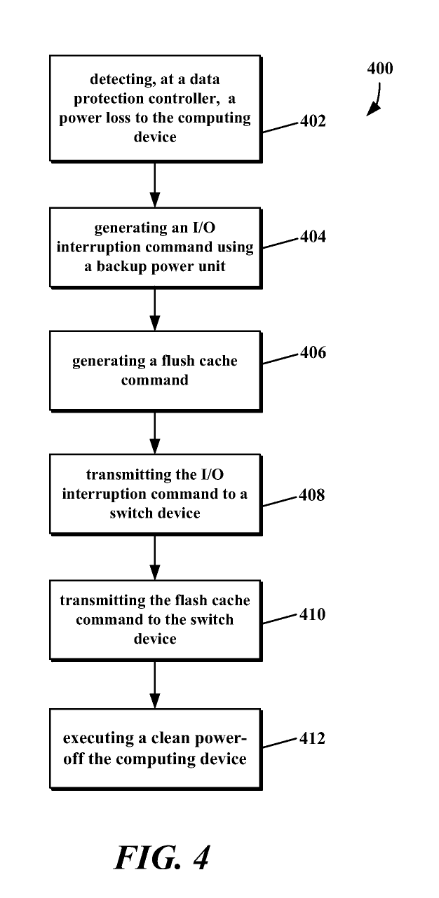

FIG. 4 is an example flow diagram 400 for an example flow diagram for a power loss protection system, according to some embodiments. It should be understood that there can be additional, fewer, or alternative steps performed in similar or alternative orders, or in parallel, within the scope of the various embodiments unless otherwise stated.

At step 402, a data protection controller can receive a signal that can indicate a power loss at a computing device. For example, with reference to FIG. 1, data protection controller 116 can be any management CPU that is operable to manage the data protection at the event of an abrupt power loss. According to some embodiments, data protection controller 116 can be a BMC. Data protection controller can include a data protection unit 117 that is operable to provide data protection to stolid state drive 108. For example, data protection unit 117 can detect a power loss of computing system 102 by receiving a power signal indicating a power loss. Data protection unit 117 can also receive signals from a voltage meter associated with a regular power supply (not shown) of host computing system 102.

At step 404, the data protection controller can use power supplied by a backup power unit to generate an I/O interruption command for a switch device. For example, upon receiving the power loss signal, data protection unit 117 or data protection controller 116 can generate input/output interruption commands that are operable to cease PCIe switch 106 to receive I/O commands from storage controller 104. For example, PCIe switch 106 can disable transmission of I/O commands from storage controller 104.

At step 406, the data protection controller can further generate a flush command for a storage controller associated with the computing device. For example, data protection unit 117 or data protection controller 116 can generate flush cache commands and transmit them to PCIe switch 106. PCIe switch 106 can consequently transmit or broadcast the flush cache commands to SSD controller 110, which is configured to copy and save unsaved data in volatile cache 112 to non-volatile storage 114 consequently.

At step 408, the data protection controller can transmit the input/out interruption command to the switch device, wherein the switch device is configured to disable transmission of at least one input/output command from the hosting system. For example, The I/O interruption commands can enable PCIe switch 106 to stop receiving I/O write commands and I/O read commands from storage controller 104.

At step 410, the data protection controller can transmit the flush cache command to the switch device, wherein the switch device is configured to transmit the flush cache command to the storage controller of the computing device. For example, SSD controller 110 can be any management CPU that is operable to execute firmware level software instructions related to solid state drive 108. In response to the flush cache commands, SSD controller 110 can, using power supplied by backup power unit 118, store unsaved data from volatile cache 112 to non-volatile storage 114. The unsaved data exposed to the loss at least includes in-transit user data and system data between the host system and the storage device and uncommitted data that is temporarily stored in the volatile cache of the storage device.

At step 412, the computing device can execute a clean power-off. For example, during the clean power-off, the unsaved data including in-transit user/system data and uncommitted data in the volatile cache can be properly saved in the non-volatile storage to prevent data loss. Additional mechanism can be executed to preserve system integrity during the clean power-off.

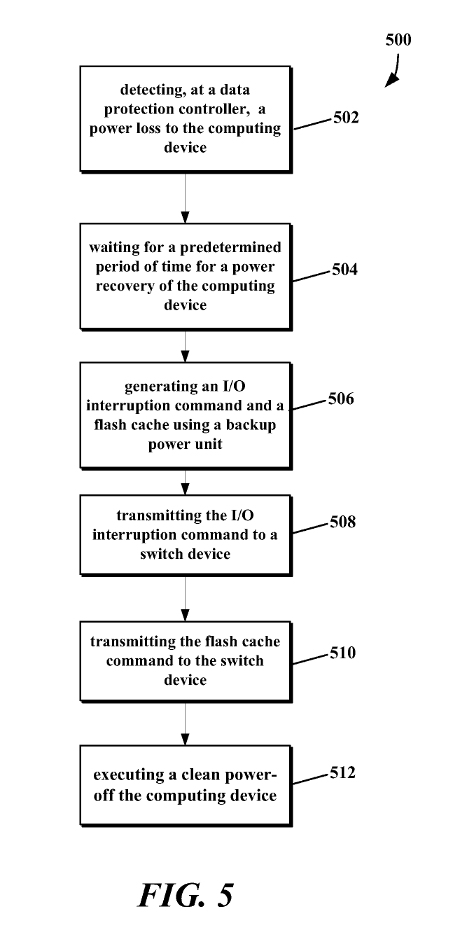

FIG. 5 is another example flow diagram 500 for an example flow diagram for a power loss protection system, according to some embodiments, according to some embodiments. It should be understood that there can be additional, fewer, or alternative steps performed in similar or alternative orders, or in parallel, within the scope of the various embodiments unless otherwise stated.

At step 502, a data protection controller can receive a signal that can indicate a power loss at a computing device. For example, with reference to FIG. 2, data protection controller 216 can be a BMC. Data protection controller can include a data protection unit 217 that is operable to provide data protection to a plurality of solid state drives. For example, data protection unit 217 can detect a power loss of computing system 202 by receiving a power signal indicating a power loss. Data protection unit 217 can also receive signals from a voltage meter associated with a regular power supply (not shown) of host computing system 202.

At step 504, the data protection controller can wait for a predetermined period of time for a power recovery of the computing device. For example, before generating commands to initiate a clean power-off, data protection controller 216 can wait for a predetermined period of time for a power recovery of host computing system 202. During this predetermined period of time, backup power unit 218 can supply the requisite power to host computing system for a normal operation. This feature can avoid an unnecessary shut-down at the event of a brief power loss. Additionally, data protection controller 216 can determine the predetermined period for which back power unit 218 can provide sufficient power for host computing system 202. Approaching the predetermined period of time, if the main power has not been resumed, data protection controller 216 can initiate the clean shut-down process, including generate 1) an I/O interruption command to stop a plurality of PCIe switches to receive more I/O commands; and 2) the flush cache commands to the plurality of PCIe switches to be transmitted to a plurality of solid state drives for a clean power-off as disclose herein.

At step 506, the data protection controller can use power supplied by a backup power unit to generate an I/O interruption command and a flush cache command using the backup power unit. For example, data protection unit 217 or data protection controller 216 can generate input/output interruption commands that are operable to cease PCIe switches 206 and 220 to receive I/O commands from storage controller 204. For example, data protection unit 217 or data protection controller 216 can generate flush cache commands.

At step 508, the data protection controller can transmit the input/out interruption command to the switch devices, wherein the switch devices are configured to disable transmission of at least one input/output command from the hosting system. For example, The I/O interruption commands can enable PCIe switch 206 to stop receiving I/O write commands and I/O read commands from storage controller 204.

At step 510, the data protection controller can transmit the flush cache command to the switch devices, wherein the switch devices are configured to transmit the flush cache command to the plurality of storage controllers of the computing device. For example, SSD controller 210 can be any management CPU that is operable to execute firmware level software instructions related to solid state drive 208. In response to the flush cache commands, SSD controller 210 can, using power supplied by backup power unit 218, store unsaved data from volatile cache 212 to non-volatile storage 214. The unsaved data exposed to the loss at least includes in-transit user data and system data between the host system and the storage device and uncommitted data that is temporarily stored in the volatile cache of the storage device.

At step 512, the computing device can execute a clean power-off. For example, during the clean power-off, the unsaved data including in-transit user/system data and uncommitted data in the volatile caches can be properly saved in the non-volatile storages to prevent data loss. Additional mechanism can be executed to preserve system integrity during the clean power-off.

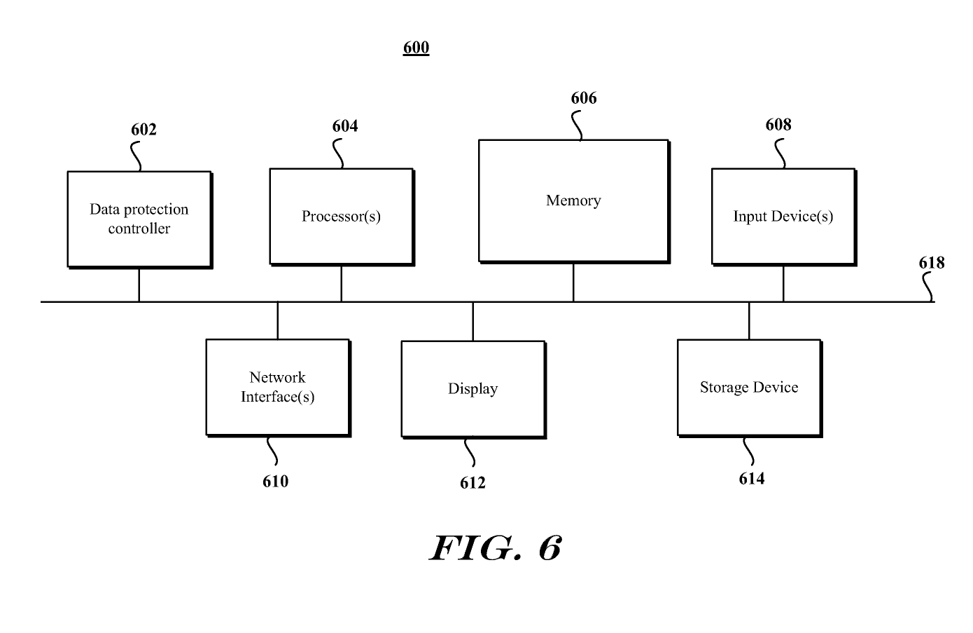

FIG. 6 illustrates an example system architecture 600 for implementing the systems and processes of FIGS. 1-5. Computing platform 600 includes a bus 618 which interconnects subsystems and devices, such as: data protection controller 602, processor 604, system memory 606, input device 608, a network interface(s) 610, display 612, and storage device 614. Processor 604 can be implemented with one or more central processing units (“CPUs”), such as those manufactured by Intel® Corporation—or one or more virtual processors—as well as any combination of CPUs and virtual processors. Computing platform 600 exchanges data representing inputs and outputs via input-and-output devices input devices 608 and display 612, including, but not limited to: keyboards, mice, audio inputs (e.g., speech-to-text devices), user interfaces, displays, monitors, cursors, touch-sensitive displays, LCD or LED displays, and other I/O-related devices.

According to some examples, computing architecture 600 performs specific operations by processor 604, executing one or more sequences of one or more instructions stored in system memory 606. Computing platform 600 can be implemented as a server device or client device in a client-server arrangement, peer-to-peer arrangement, or as any mobile computing device, including smart phones and the like. Such instructions or data may be read into system memory 606 from another computer readable medium, such as a storage device. In some examples, hard-wired circuitry may be used in place of or in combination with software instructions for implementation. Instructions may be embedded in software or firmware. The term “computer readable medium” refers to any tangible medium that participates in providing instructions to processor 604 for execution. Such a medium may take many forms, including, but not limited to, non-volatile media and volatile media. Non-volatile media includes, for example, optical or magnetic disks and the like. Volatile media includes dynamic memory, such as system memory 606.

Common forms of computer readable media includes, for example: floppy disk, flexible disk, hard disk, magnetic tape, any other magnetic medium, CD-ROM, any other optical medium, punch cards, paper tape, any other physical medium with patterns of holes, RAM, PROM, EPROM, FLUSH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 618 for transmitting a computer data signal.

In the example shown, system memory 606 can include various software programs that include executable instructions to implement functionalities described herein. In the example shown, system memory 606 includes a log manager, a log buffer, or a log repository—each can be configured to provide one or more functions described herein.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed is:

1. A computer-implemented method, comprising:
detecting, at a data protection controller associated with a storage device of a computing device, a signal indicating a power loss to the computing device;
first generating, in response to the signal, using power supplied by a backup power unit of the computing device, an input/out interruption command for a switch device associated with the storage device;
second generating a flush cache command for a storage controller of the computing device;
first transmitting the input/out interruption command to the switch device, the switch configured to disable transmission of at least one input/output command;
second transmitting the flush cache command to the switch device, the switch device configured to transmit the flush cache command to the storage controller of the computing device; and
executing a clean power-off of the computing device.

2. The computer-implemented method of claim 1, further comprising:
waiting for a predetermined period of time between the detecting and the first generating, for a power recovery of the computing device, the predetermined period of time being based at least in part on a period of time for which the backup power unit can provide sufficient power to the computing device to prevent data loss.

3. The computer-implemented method of claim 1, further comprising:
flushing, in response to receiving the flush cache command, data stored in a volatile storage of the storage device to a non-volatile storage of the storage device.

4. The computer-implemented method of claim 3, further comprising:
receiving, at the data protection controller, an acknowledgement command indicating that the data stored in the volatile storage of the storage device has been stored in the non-volatile storage of the storage device.

5. The computer-implemented method of claim 1, wherein the switch device is one of a serial ATA express (SATA) switch, a serial-attached SCSI (SAS) switch, or a peripheral component interconnect express (PCIe) switch.

6. The computer-implemented method of claim 1, wherein the at least one input/output command comprises at least one of a write command or a read command generated by a storage host driver associated with the computing device.

7. The computer-implemented method of claim 1, wherein storage device comprises one of a solid state drive, a hard disk drive or a flash drive.

8. The computer-implemented method of claim 1, further comprising:
storing, using the storage controller, unsecured data from a volatile cache of the storage device to a non-volatile storage medium of the storage device.

9. The computer-implemented method of claim 1, further comprising:
synchronizing, using the storage controller, one or more metadata tables stored in a volatile cache of the storage device.

10. The computer-implemented method of claim 1, wherein the data protection controller is a baseboard management controller.

11. A system, comprising:
a processor; and
a memory including instructions that, if executed by the system, cause the system to:
detect, at a management CPU associated with a plurality of storage devices of a computing device, a signal indicating a power loss of the computing device;
first generate, in response to the signal, using power supplied by a backup power unit of the computing device, an input/out interruption command for a respective switch device associated with each of the plurality of the storage devices;
second generate a flush cache command for the plurality of the storage devices;
first transmit the input/out interruption command to the respective switch device associated with the each of the plurality of the storage devices, the respective switch device configured to disenable transmission of at least one input/output command;
second transmit the flush cache command to the respective switch device, the respective switch device configured to transmit the flush cache command to the each of the plurality of the storage devices; and
execute a clean power-off of the computing device.

12. The system of claim 11, wherein the instructions further cause the system to:
wait for a predetermined period of time between the detect and the first generate, for a power recovery of the computing device.

13. The system of claim 11, wherein the instructions further cause the system to:
flush, in response to receiving the flush cache command, data stored in a respective volatile storage of the each of the plurality of the storage devices to a respective non-volatile storage of the each of the plurality of the storage devices.

14. The system of claim 11, wherein the instructions further cause the system to:
synchronize, using the storage controller, one or more metadata tables stored in a volatile cache of the storage device.

15. The system of claim 11, wherein the instructions further cause the system to:
store, using the storage controller, unsecured data from a volatile cache of the storage device to a non-volatile storage medium of the storage device.

16. The system of claim 11, wherein the instructions further cause the system to:
receive, at the data protection controller, a plurality of acknowledgement commands each indicating data stored in a respective volatile storage of the each of the plurality of the storage devices has been committed to a respective non-volatile storage of the each of the plurality of the storage devices.

17. The system of claim 11, wherein the each of the plurality of the storage devices further comprises a respective storage controller configured to execute the flush cache command.

18. The system of claim 11, wherein the switch device is one of a peripheral component interconnect express (PCIe) switch, a serial ATA express (SATA) switch, or a serial-attached SCSI (SAS) switch.

19. A computer program stored on a non-transitory computer-readable storage medium, the computer program comprising:
code for detecting, at a data protection controller associated with a storage device of a computing device, a signal indicating a power loss to the computing device;
code for waiting for a predetermined period of time for a power recovery of the computing device.
code for first generating, in response to the signal, using power supplied by a backup power unit of the computing device, an input/out interruption command for a switch device associated with the storage device;
code for second generating a flush cache command for a storage controller of the computing device;
code for first transmitting the input/out interruption command to the switch device, the switch configured to disable transmission of at least one input/output command;
code for second transmitting the flush cache command to the switch device, the switch device configured to transmit the flush cache command to the storage controller of the computing device; and
code for executing a clean power-off of the computing device.

20. The computer program of claim 19, further comprising:
code for determining the predetermined period of time for which the backup power unit of the computing device can provide sufficient power to operate the computing device.
